(19) United States
(12) Patent Application Publication
(10) Pub. No.: US 2007/0100959 A1
(43) Pub. Date: May 3, 2007

(54) Customizing RSS content for use over a network

(75) Inventors: Matthias Eichstaedt, Sunnyvale, CA (US); Yunzhong Chen, San Jose, CA (US); Michael R. Cook, San Jose, CA (US); Ronald W. Ludwig, Tracy, CA (US); Sotirios Matzanas, San Francisco, CA (US); Kamlesh C. Pandey, Sunnyvale, CA (US); Adam Prishtina, San Jose, CA (US); Stephen W. Swales, Sunnyvale, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/262,287

(22) Filed: Oct. 28, 2005

(51) Int. Cl. G06F 15/16

(52) U.S. Cl. 709/217

(57) ABSTRACT

A system, apparatus, and method are directed to managing customization of a subscription and/or an alert for an RSS feed over a network. An RSS Content Source (RCS) may provide feed templates that may be used to modify a subscription interface. The RCS may further provide additional feed templates that are useable to modify an RSS alert and/or the RSS content. Moreover, a RSS subscription service provider may also provide one or more feed templates. The feed templates may include co-branding information, advertisements, related RSS feeds, services related to the RCS's business, products available from the RCS, or the like. The feed templates may further change a look and feel of a subscription interface, and/or RSS alert to enhance subscriber loyalty, and improve business opportunities. In one embodiment, the feed templates include material that may change based, in part, on a subscriber's behavior.

### FIELD OF THE INVENTION

The present invention relates generally to messaging over a network, and more particularly, but not exclusively, to a system and method for managing customized subscriptions and customized alerts for an RSS feed over a network.

### BACKGROUND OF THE INVENTION

The amount of readily accessible content available to a user over a network, such as the Internet, has increased almost exponentially for the past several decades. Moreover, there is little indication that this rate of increase in accessible content will not continue in the foreseeable future. Providers of such content include blogs, news sources, sports sources, weather sources, libraries, friends, universities, businesses, and the like. Many of these content providers provide new or changed content almost regularly.

Because of the large amount of changing content, users often seek mechanisms that help them manage notifications of such changes. One such mechanism uses an RSS feed. Generally, RSS provides web content or summaries of web content together with links to the full versions of the content, and other meta-data. This information may be delivered as an XML file typically through an RSS feed, webfeed, RSS stream, or RSS channel. RSS feeds enable a user to subscribe to a content provider's website, or the like, and receive an alert indicating when a change to the content has occurred.

With so many content providers, providing RSS content to users, many are struggling with developing additional approaches that will build subscriber loyalty, and to further improve on opportunities to grow their business based on their subscriber base. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a network device that may be included in a system implementing the invention;

FIG. 3 shows one embodiment of a client device that may be included in a system implementing the invention;

FIG. 4 shows one embodiment of an RSS content source feed subscription dialog customized with a feed template;

FIG. 5 shows one embodiment of another an RSS content source feed subscription dialog customized with a feed template;

FIG. 6 shows one embodiment of an RSS alert customized with a feed template;

FIG. 7 illustrates a logical flow diagram generally showing one embodiment of a process for managing a customized RSS content source feed subscription dialog;

FIG. 8 illustrates a logical flow diagram generally showing one embodiment of a process for managing a customized RSS content source alert to a subscriber; and

FIG. 9 illustrates a logical flow diagram generally showing one embodiment of a process for customizing an RSS feed based on an input from a subscription dialog or an RSS alert, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. The phrase “in another embodiment” as used herein does not necessarily refer to a different embodiment, although it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term RSS refers to any of a family of file formats and associated mechanisms usable to enable a user to subscribe to and receive network syndicated content from a content provider over a network. Typically, the file format that is employed is XML, however, the invention is not so limited, and other file formats may be used. Syndicated content includes, but is not limited to such content as news feeds, events listings, news stories, blogs, headlines, project updates, excerpts from discussion forums, or even corporate information. The abbreviation RSS as used herein includes at least the following: Rich Site Summary, RDF Site Summary, and Really Simple Syndication. Furthermore, although RSS is described, the invention is not limited to RSS. For example, Atom, a syndication specification adopted by the Internet Engineering Task Force (IETF) may also be employed. As used throughout this application, including the claims, RSS refers to RSS, Atom, and all syndication file formats derived therefrom.

As used herein, the terms “feed,” and “RSS feed,” sometimes called a channel or RSS channel, refers to any mechanism that enables content notification and/or content access from an RSS content source (RCS). An RSS feed mechanism may include a push mechanism, and/or a pull mechanism, wherein a pull mechanism may further include a query mechanism. In one embodiment, an RSS feed may also represent a summary of content formatted in an RSS format and available for access. An RCS may provide more than one feed.

Briefly stated, the present invention is directed towards a system, method, and apparatus for managing a customized subscription and/or alert for an RSS feed over a network. The invention enables an RSS feed provider to provide feed templates that may be used to modify a subscription interface to a subscriber. The RSS feed provider may further provide additional feed templates that are useable to modify an RSS feed alert to the subscriber. However, the invention is not restricted to the feed templates being provided by the RSS feed provider. For example, a subscription service provider, or the like, may also provide feed templates useable with a subscription dialog, and/or an RSS feed alert, or the like.

In one embodiment, the RSS feed alert may include at least a portion of the RSS feed's content. The feed templates may include an advertisement, a related RSS feed, additional content, products, and/or services available from the RSS feed provider, a third party, the subscription service provider, or the like. In one embodiment, the feed templates include co-branding information that provides brand and/or trademark information. The feed templates may further change a look and feel of a subscription interface, and/or RSS feed alert to enhance subscriber loyalty, and improve business opportunities.

Illustrative Operating Environment

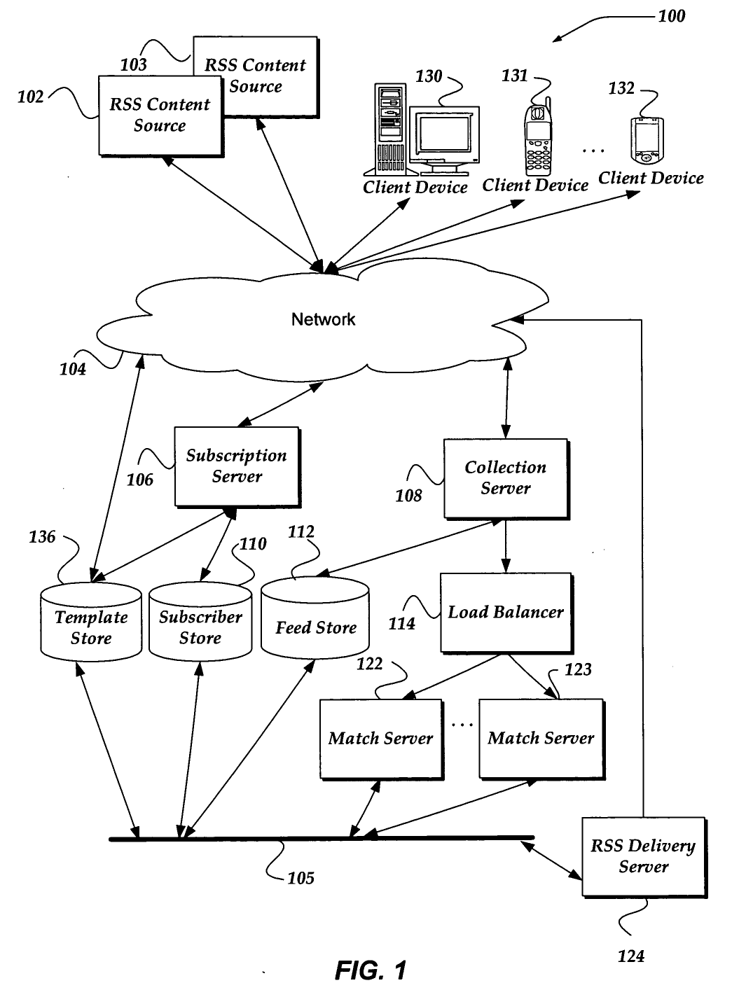

FIG. 1 shows components of an exemplary environment in which the invention may be practiced. Not all the components shown may be required to practice the invention, and variations in the arrangement and type of the components may be made without departing from the spirit or scope of the invention.

As shown in the figure, system 100 includes RCSs 102-103, client devices 130-132, networks 104-105, subscription server 106, collection server 108, load balancer 114, match servers 122-123, RSS delivery server 124, template store 126, subscriber store 110, and feed store 112.

Network 104 enables communication between RCSs 102-103, client devices 130-132, subscription server 106, template store 136, and collection server 108. Subscription server 106 is also in communication with subscriber store 110 and template store 136. Collection server 108 is in communication also with feed store 112, and load balancers 114. Load balancers 114 are also in communication with match servers 122-123. Match servers 122-123 are in further communication with RSS delivery server 124, subscriber store 110, and feed store 112. RSS delivery server 124 is further in communication with template store 136.

Client devices 130-132 may include virtually any computing device that is configured to receive and to send information over a network, such as network 104. Such devices may include portable devices such as, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, and the like. Client devices 130-132 may also include other computing devices, such as personal computers, multiprocessor systems, microprocessor-based or programmable consumer electronics, network PCs, and the like. As such, client devices 130-132 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 130-132 also may include at least one client application that is configured to receive content from another computing device. The client application may include a capability to provide and receive textual content, graphical content, audio content, alerts, messages, notifications, and the like. Moreover, client devices 130-132 may be further configured to communicate a message, such as through a Short Message Service (SMS), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Client devices 130-132 may also include a client application that is configured to enable a user of the device to subscribe to at least one RSS feed. Such subscription may enable the user to receive through the client device an alert (or notification) that content is available for access. In another embodiment, the alert may include at least a portion of the content. Such content may include, but is not limited to, stock feeds, news articles, personal advertisements, shopping list prices, images, search results, blogs, sports, weather reports, or the like. Moreover, the alerts may be provided to client devices 130-132 using any of a variety of delivery mechanisms, including IM, SMS, MMS, IRC, EMS, audio messages, HTML, email, or another messaging application.

In some cases, a user could subscribe to an alert for certain content to be provided by all mechanisms available on the client device, and another alert for other registered content to be provided by a single delivery mechanism. Additionally, some alerts may be provided through RSS delivery server 124 with a push mechanism to provide a relatively immediate alert. In this case, the invention might employ stored subscriber profile information to deliver the alert to the user using a variety of delivery mechanisms. In contrast, other alerts can be provided with a pull mechanism where RSS delivery server 124 provides an alert and/or content in response to a request from a subscriber. The requests can also be scheduled at predefined times to provide alerts.

For client devices 130-132 that may reside behind a Network Address Translation (NAT) device (not shown) over network 104, the pull mechanism may employ a connection established by a pull request to send the alert to the subscriber. In one embodiment, how often the pull alert might be provided may be determined by a frequency with which a subscriber makes a pull request for the alert and/or content.

The client application residing on client devices 130-132 may also be configured to store a history of alerts. In one embodiment, the client application may be a messaging application such as described above.

In one embodiment, client devices 130-132 may enable a subscriber to operate the computing device to make requests for data and/or services from other computers on the network. Often, the requested data resides in computing devices such as RSS delivery server 124, RCSs 102-103, or the like. Thus, in this specification, the term “client” refers to a computer's general role as a requester of data or services, and the term “server” refers to a computer's role as a provider of data or services. In general, it is possible that a computer can act as a client, requesting data or services in one transaction and act as a server, providing data or services in another transaction, thus changing its role from client to server or vice versa.

RCSs 102-103 represent virtually any network device that is configured to provide content through an RSS feed mechanism. RCSs 102-103 may include businesses, blogs, universities, friends, news sources, or the like that may provide various content, including personal content, educational content, advertisements, business content, or any of a variety of other content. RCSs 102-103 may provide the content using either a push mechanism, and/or a pull mechanism. That is, in one embodiment, at least one RCS may provide content, an alert, or the like, to collection server 108 indicating that content is available for access. In another embodiment, at least one RCS may be pulled using a variety of mechanisms, including queries, or the like, by such as collection server 108, to determine availability of content. Moreover, at least one RCS may provide more than one RSS feed. For example, RCS 102, or the like, may provide an RSS feed associated with news, another for weather, another for editorials, or still another for traffic. However, clearly, an RCS is not constrained by these examples, and others may be used, and/or implemented, without departing from the scope or spirit of the invention.

RCSs 102-103 may also provide one or more feed templates for use by subscription server 106 and/or RSS delivery server 124. Such feed templates by include a variety of information that may be provided to a subscriber, a potential subscriber, or the like. For example, RCSs 102-103 may provide feed templates that include an advertisement, a link, or the like, that may be associated with content, products, and/or services, that RCSs 102-103 may want to promote.

Devices that may operate as RCSs 102-103 include personal computers, desktop computers, multiprocessor systems, microprocessor-based or programmable consumer electronics, network PCs, servers, or the like.

Networks 104-105 are configured to couple one computing device with another computing device. Networks 104-105 may be enabled to employ any form of computer readable media for communicating information from one electronic device to another. Also, networks 104-105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Furthermore, remote computers and other related electronic devices could be remotely connected to either LANs or WANs via a modem and temporary telephone link.

Networks 104-105 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 104-105 may also include an autonomous system of terminals, gateways, routers, and the like connected by wireless radio links, and the like. These connectors may be configured to move freely and randomly and organize themselves arbitrarily, such that the topology of networks 104-105 may change rapidly.

Networks 104-105 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, and future access networks may enable wide area coverage for mobile devices, such as one or more of client devices 130-132, with various degrees of mobility. For example, networks 104-105 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 104-105 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 104-105 may include virtually any wired and/or wireless communication mechanisms by which information may travel between one computing device and another computing device, network, and the like. In one embodiment, network 105 may represent a LAN that is configured behind a firewall (not shown), within a business data center, or the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Subscription server 106 may include virtually any network device that is configured to provide an interface for use with a client device, such as client devices 130-132 for managing an RSS alert. In one embodiment, the interface may be a user interface. The user interface may be configured to enable a user to subscribe to an RSS feed, unsubscribe to an RSS feed, modify options associated with an RSS feed, or the like. Interface menus may be arranged for the user to subscribe to an RSS feed. In one embodiment, subscription server 106 may be managed by a subscription service provider.

Subscription server 106 may provide different menus, interfaces, or the like based on a variety of pre-determined criteria. For example, one interface may be provided when there is no RSS feed information associated with the user, another interface when the user has already subscribed to at least one RSS feed, or the like. In any event, subscription server 106 may employ the interfaces to request from the user, various subscriber profile information, including, but not limited to a user identifier (user-id), user name, alert type, alert sub-type, frequency of receiving the alert, mechanism to receive the alert, RSS feed associated with an alert or other information. Subscription server 106 may store such subscriber profile information in subscriber store 110.

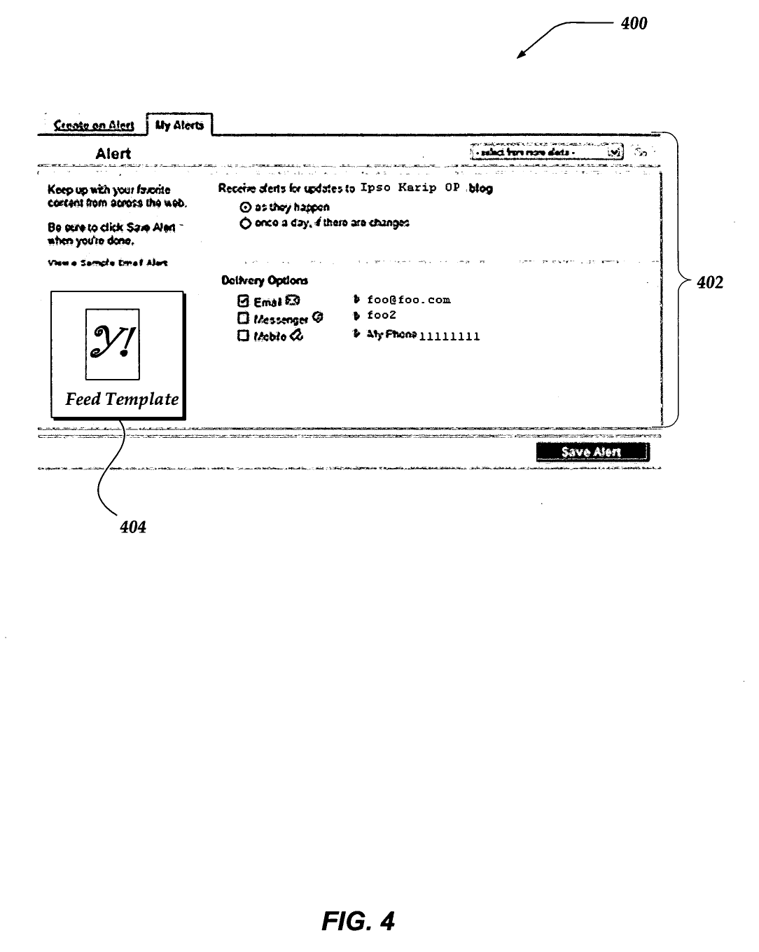

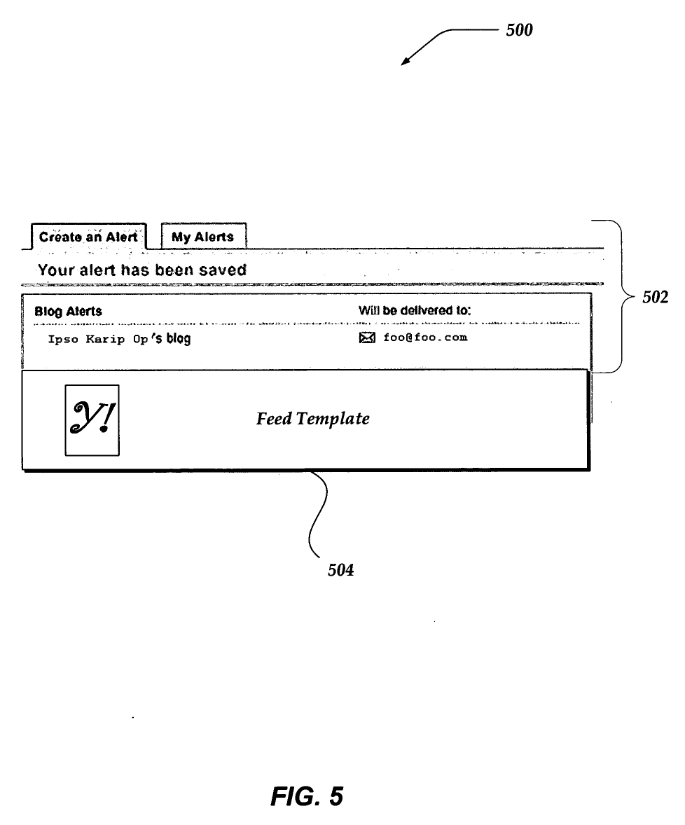

Subscription server 106 may also provide to client devices 102-103 a customized menu, interface, or the like, based in part on a feed template from RCS 102-103, RSS delivery server 124, a third party, a subscription service provider, or the like. For example, subscription server 106 may receive through template store 136 one or more feed templates that may be employed to modify a look and/or feel of a subscription interface. Such feed templates may include a variety of information, including, but not limited to an advertisement; a description of an RCS, a third party, the subscription service provider, or the like; a brand, trademark, or the like; a link to another network site, such as an RSS feed, a product, service, or the like. The feed templates may be selected for use based on a variety of criteria, including a relationship between an RCS and subscription service provider, a fee, a license agreement, a behavior of a user, or the like. Example embodiments of subscription interfaces modified with feed templates are described in more detail below in conjunction with FIGS. 4-5.

In one embodiment, subscription server 106 may be configured to provide an application programming interface (API), or the like, for use with a client device, such as client devices 130-132. Such API may include, but is not limited to, a web services interface, a remote procedure call (RPC) interface, or the like. The web services interface may include WSDL, SOAP-XML, or the like. The API may be configured to enable a client application running on a client device to subscribe to an RSS feed, unsubscribe to an RSS feed, modify options associated with an RSS feed, or the like.

Subscriber store 110 includes virtually any device that may be configured to receive and manage subscriber profile information, including, but not limited to a volatile and nonvolatile, removable and non-removable media implemented in any method or technology for storage of subscriber profile information, including computer readable instructions, data structures, program modules, or other data. Examples of computer storage media usable for subscriber store 1 10 include RAM, CD-ROM, DVD, optical storage, magnetic cassettes, magnetic tape, disk storage and/or any other magnetic storage devices, and/or any other medium that can store information that can be accessed by a computing device. Moreover, subscriber store 1 10 may be configured to employ a variety of mechanisms to manage subscriber profile information, including, documents, tables, files, scripts, applications, databases, spreadsheets, or the like.

Subscriber profile information may include a variety of information, including a user identifier (user-id), subscriber name, alert type, alert sub-type, frequency of receiving the alert, or RSS feed. Subscriber profile information may also include information about which mechanism the subscriber has indicated to be used for receiving the alert, including email, SMS, IM, browser, audio, or the like. Subscriber profile information may further include information about a behavior of a subscriber. Such behavior information may include whether an alert is read, deleted without being read, has requested an alert not be sent for a period of time, whether the subscriber has clicked on information provided within a feed template, how often the subscriber has clicked on information within a feed template, or the like. Behavior information, however, is not limited to these examples, and other information about a subscriber's network related activities may be gathered and stored within subscriber store 110. In one embodiment, the subscriber has provided consent for the gathering of information about at least some of the subscriber's behaviors.

Template store 136 includes virtually any device that may be configured to receive and manage customized RSS feed templates, including, but not limited to a volatile and nonvolatile, removable and non-removable media implemented in any method or technology. Moreover, template store 136 may be configured to employ a variety of mechanisms to manage RSS feed templates, including documents, tables, files, scripts, applications, databases, spreadsheets, or the like.

In one embodiment, template store 136 may store feed templates based on the RCS, a subscriber characteristic, or the like. The feed template may include information about the RCS, co-branding information associated with the RCS, a third party, a subscription service provider, an advertisement selected based on the RSS content and/or the RCS, an advertisement selected based on a client device type, or the like. In one embodiment, the feed templates may be in a form of a script, a web page with embedded scripting instructions, an eXtensible Stylesheet Language (XSL) transformation, a URL, an HTML page, or the like. Such feed templates may be employed during a subscription action and/or an RSS alert, RSS feed content, or the like.

Collection server 108 includes virtually any network device that may be configured to determine an availability of RCS content is available by another computing device, such as client devices 130-132. Collection server 108 further provides information about the RCS content availability to feed store 112, and through load balancer 114 to match servers 122-123. Devices that may operate as collection server 108 include personal computers, desktop computers, multiprocessor systems, microprocessor-based or programmable consumer electronics, network PCs, servers, or the like.

Collection server 108 may include a ping service, query mechanism, or the like, that is configured to determine whether an RCS content is available. In one embodiment, collection server 108 may listen for content availability from a variety of pre-determined RSS feeds, such as from RCSs 102-103. In another embodiment, collection server 108 may receive a notification from RCSs 102-103 indicating that content is available for access. In one embodiment, the notification is sent to collection server 108 using a ping type of mechanism that includes an identifier of the RSS feed. In one embodiment, the RSS feed identifier is an RSS URL. Moreover, in one embodiment, the notification of RCS content may also include the content. It is further noted that an RCS may provide more than one RSS feed. Thus, an RCS may have associated with it more than one RSS feed identifier, at least one identifier for each of its RSS feeds having content.

Collection server 108 may also employ a crawler, such as a web crawler, RSS crawler, or the like, that is configured to search for RSS content over network 104. Collection server 108 may perform the crawls based on at least one pre-determined network address for an RSS content source. However, collection server 108 is not so limited. For example, collection server 108 may receive a search query for a type of content, such as from a subscriber, or the like, and perform the search query for the type of content over network 104. For example, in one embodiment, a subscriber may provide a Boolean query comprising of one or more logical operators, such as AND, OR, NOT, or the like, along with one or more search terms. Collection server 108 may provide the search query to a crawler for use in performing search for an RCS site, or the like, that may provide results that are similar to the search query. In any event, the results of crawling network 104 may be to identify RSS content sources that have RSS content. When such an RSS content source is located, collection server 108 may access the content.

Collection server 108 may further search feed store 112 to determine whether the received content has already been received for an RCS. Content may be received by collection server 108 for any of a variety of reasons, including because an RCS may provide numerous notifications over a period of time for a same content. Thus, if collection server 108 determines that the RCS content has already been received, collection server 108 may select to drop the most recent content (e.g., duplicated content). If collection server 108 determines that the received notification is for a content that has not been received, collection server 108 may provide the content to feed store 112 for storage. In addition, collection server 108 may also provide a notification of the availability of the content to load-balancer 114. In one embodiment, the notification to load-balancer 114 includes an identifier for the RSS feed having the content. In one embodiment, collection server 108 may generate an XML document which includes the RCS identifier.

Feed store 112 includes virtually any computer storage media that may be configured to receive and manage RCS content. Examples of computer storage media usable for subscriber store 110 include RAM, CD-ROM, DVD, optical storage, magnetic cassettes, magnetic tape, disk storage and/or any other magnetic storage devices, and/or any other medium that can store information that can be accessed by a computing device. Moreover, feed store 112 may be configured to employ a variety of mechanisms to manage RCS content, including, documents, tables, files, scripts, applications, databases, spreadsheets, or the like. In one embodiment, feed store 112 may store the RCS content based, in part, on an RSS feed identifier. The RCS content may also include additional information associated with the RCS content, including, but not limited to a time stamp indicating when the RCS content was received.

Load-balancer 114 may include virtually any device that manages network traffic. Such devices include, for example, routers, proxies, firewalls, load balancers, cache devices, devices that perform network address translation, any combination of the preceding devices, and the like. Load-balancer 114 may be implemented using one or more personal computers, servers, multiprocessor systems, microprocessor-based or programmable consumer electronics, network PCs, radio frequency (RF) devices, infrared (IR) devices, integrated devices combining one or more of the preceding devices, and the like. Such devices may be implemented solely in hardware or in hardware and software. In one embodiment, load-balancer 114 may be implemented as at least one application residing within collection server 108. Moreover, although multiple load-balancers are not illustrated, the invention is not constrained to use of a single load-balancer. For example, multiple load-balancers may be implemented across distinct servers, multiple load-balancers may be implemented as multiple processes within a single server, or the like, without departing from the scope or spirit of the invention. Load-balancer 114 may be configured to control a flow of data delivered to an array of servers, such as match servers 122-123. In one embodiment, load-balancer 114 receives an XML document that may include an RSS URL associated with an RCS, such as RCSs 102-103. Load-balancer 114 may direct the document to a particular match server based on network traffic, network topology, capacity of a server, content requested, an authentication, or authorization status, and a host of other traffic distribution mechanisms. For example, in one embodiment, load-balancer 114 may distribute the XML documents across match servers 122-123 using a round-robin mechanism. However, other load-balancing mechanisms may also be employed, without departing from the scope or spirit of the invention. For example, load-balancer 114 may also control a flow of data based on an RSS feed identifier, RCS content type, a subscriber, a delivery type, or the like. In one embodiment, load-balancer 114 may be configured to deliver RSS feed identifiers based on a particular RCS content type, a subscriber, a delivery type, or the like.

Match servers 122-123 include virtually any network device that may be configured to receive an indication of an RCS content availability, and to create matches based, in part, on subscriber profile information, for the RCS content and to send the matches to RSS delivery server 124 for distribution to the matched subscribers.

Match servers 122-123 may further determine, at least in part, whether received RCS content has been sent to the matched subscribers. If the RCS content has already been sent, then match servers 122-123 may select to not send the matches to RSS delivery server 124. RCS content may have already been sent to the matched subscribers, for example, because one of the other match servers already sent the content.

Devices that may operate as match servers 122-123 include personal computers, desktop computers, multiprocessor systems, microprocessor-based or programmable consumer electronics, network PCs, servers, or the like. Moreover, although multiple match server devices are illustrated, the invention is not constrained to multiple devices. For example, multiple match servers may be implemented as multiple processes within a single server device, without departing from the scope or spirit of the invention.

RSS delivery server 124 includes virtually any network device that is configured to prioritize and manage distribution of alerts to a client device, such as client devices 130-132. RSS delivery server 124 may receive information from match servers 122-123 indicating that pushed content, pulled content, or the like is available. RSS delivery server 124 may further receive from match servers 122-123 a user identifier indicating which subscriber to provide the alert. RSS delivery server 124 may receive alert content from feed store 112, and additional subscriber profile information from subscriber store 110 to determine when and how to deliver the alert to a subscriber.

As alerts are prepared and delivered, a monitor mechanism (not shown) may monitor the flow of alerts for patterns and/or other insights. For example, the monitor mechanism may track and/or access information about a subscriber's behavior, such as navigating to Web sites, making online purchases, selecting information from a feed template, or the like. The tracked behavior also may indicate a subscriber's interests which may also be stored in the subscriber's profile in subscriber store 110. When an alert is to be delivered, it may be routed to one or more appropriate servers (not shown) for delivery by the subscriber's preferred method(s). For example, email alerts can be delivered via bulk servers. Alerts to wireless mobile devices can be delivered via a wireless server. Instant message alerts can be delivered via an instant message server, and so forth. Each alert may be generally communicated over network 104 to a client device identified in the subscriber's profile. Thus, the subscriber can indicate that the alert be delivered to one ore more of a client devices.

In one embodiment, RSS delivery server 124 may also receive various feed templates that may be combined with the RCS alerts, RCS content, or the like. In one embodiment, RSS delivery server 124 may receive the feed templates from RCSs 102-103 through template store 136. RSS delivery server 124 may employ the feed template based on the RCS, a characteristic of a subscriber, or the like. For example, the feed template may be selected to provide additional information about the RCS. Thus, the feed template may include co-branding information associated with the RCS, a third party source, an advertisement selected based at least in part on the RSS feed content, an advertisement selected based on a client device type, or the like. The advertisement may also be selected based on pre-defined keywords/advertisement words associated with the RSS feed content, the RCS, subscription service provider, or the like. In one embodiment, the advertisement may trigger a transaction to bill an associated account when the advertisement is sent to a subscriber. However, the invention is not so limited. For example, in another embodiment, the subscription service provider may receive revenue for a feed template sent to a subscriber. Thus, based on information associated with the RSS feed template, at least one billing account may be charged. In one embodiment, the charge may be associated with receiving the feed template into template store 136. In another embodiment, the charge may be associated with sending the feed template to a subscriber. It is important to note, the such charges may also be associated with feed templates related to activities of subscription server 106.

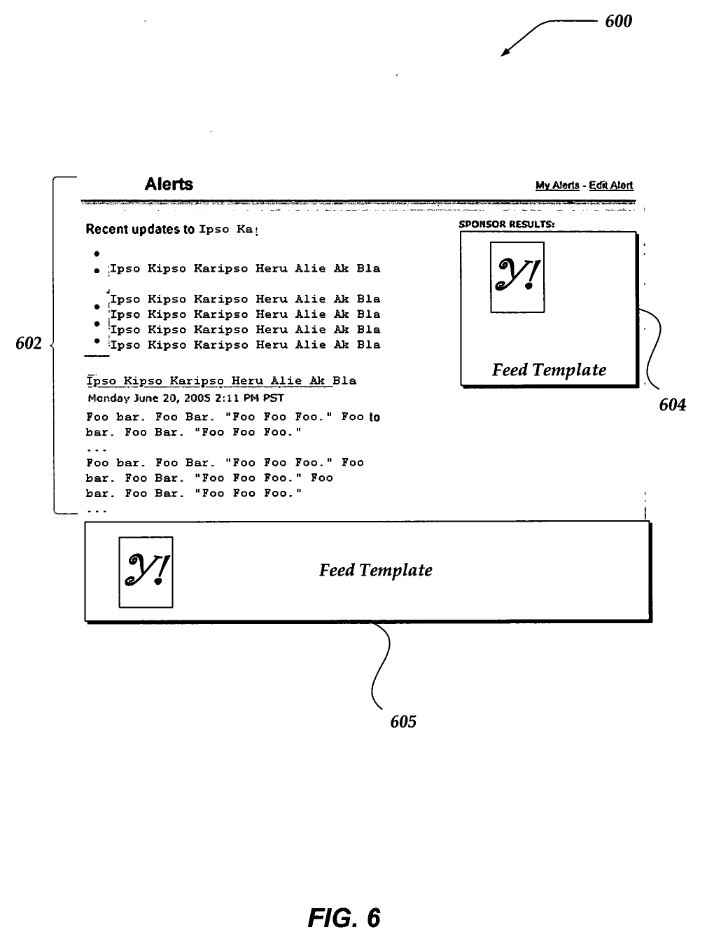

In another embodiment, a subscriber's behavior, including what type of RSS content the subscriber has requested, or the like, may be employed to customize the RCS alert, the RCS content, or the like. In yet another embodiment, the feed templates may modify the RSS content, such modification including appending, deleting, and/or rearranging, at least a portion the content. The modifications may be also based on the RSS content, the RCS, an advertisement selected based on a client device type, or the like. The modifications may further include of combining content from an external content source, such as from a web page, from other RCS, the RCS, at least some portion of the subscriber profile information, an advertisement selected based on a client device type, or some combination thereof, or the like. One example embodiment of a delivery interface modified with feed templates is described in more detail below in conjunction with FIG. 6.

Although not illustrated, a mirror interface may be used to communicate with one or more mirrored components of system 100, including, but not limited to match servers 122-123, feed store 112, subscriber store 110, and/or template store 136. Thus, any, or all of system 100 may be reproduced for parallel processing, and/or failover processing. Such mirror interface may comprise one or more communication interfaces and/or associated network devices.

Illustrative Network Device

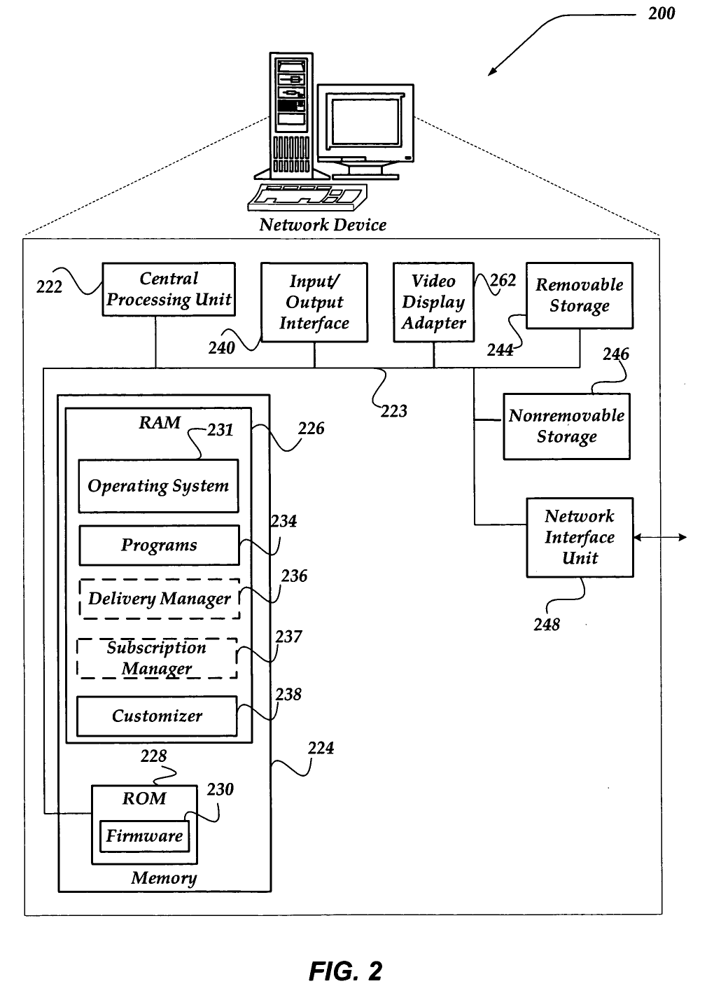

FIG. 2 shows one embodiment of a network device that may be included in a system implementing the invention. It will be appreciated that not all components of network device 200 are illustrated, and that network device 200 may include more or less components than those shown in FIG. 2. Network device 200 may be employed to operate as subscription server 106 and/or RSS delivery server 124 of FIG. 1. As illustrated, network device 200 may also be employed to operate as both subscription server 106 and RSS delivery server 124 of FIG. 1.

As shown in FIG. 2, network device 200 includes at least one central processing unit 222 in communication with main memory 224 by way of bus 223 or the like. Main memory 224 generally includes RAM 226, ROM 228, and may include other storage means, such as one or more levels of cache (not shown). Main memory 224 illustrates a type of processor-readable media, namely computer storage media. Computer storage media may include volatile and nonvolatile, removable and non-removable media implemented in any method or technology for storage of information, such as processor-executable instructions, data structures, program modules, and the like. Other examples of computer storage media include EEPROM, flash memory or other semiconductor memory technology, CD-ROM, DVD or other optical storage media, magnetic tape, magnetic disk storage or other magnetic storage devices, or any other medium that can be used to store the desired information and that can be accessed by a computing device.

Network device 200 includes an input/output interface 240 for communicating with input/output devices, such as a keyboard, mouse, printer, and the like. A user, such as a system administrator, or the like, of network device 200 may use input/output devices to interact by way of a user interface that may be separate from or integrated with operating system 231 and/or programs 234. Interaction with the user interface may include interaction by way of a visual display, using video display adapter 242.

Network device 200 may include secondary storage for storage of program modules, data, and the like not in main memory 224, including removable computer-readable storage 244 and/or non-removable computer-readable storage 246. Removable storage 244 may comprise one or more of optical disc media, floppy disks, and magnetic tape readable by way of an optical disc drive, floppy disk drive, and tape drive, respectively. Secondary storage may also include flash memory or other memory technology and generally includes any medium usable for storage of information and accessible by a computing device.

By way of network interface unit 248, network device 200 may communicate with a WAN, such as the Internet, a LAN, a wired telephone network, a wireless communications network, or some other communications network. Network interface unit 244 may comprise a transceiver, a network interface card, and the like. Network interface unit 244 is sometimes known as a transceiver, transceiving device, or network interface card (NIC).

Main memory 224 typically stores firmware 230 for boot-loading and controlling low-level operation of network device 200. Main memory 224 also stores programs for loading and execution by central processing unit 222, such as operating system 231 and other programs 234, which may include, for example, server applications, client applications, networking applications, messaging applications such as applications for RSS communication, and the like. Main memory 224 may further include delivery manager 236, subscription manager 237, and customizer 238. As illustrated, delivery manager 236 and/or subscription manager 237 might not both reside in a same network device (thus, the dashed boxes). However, the invention is not so constrained, and both components may reside in the same network device, as illustrated, without departing from the scope or spirit of the invention.

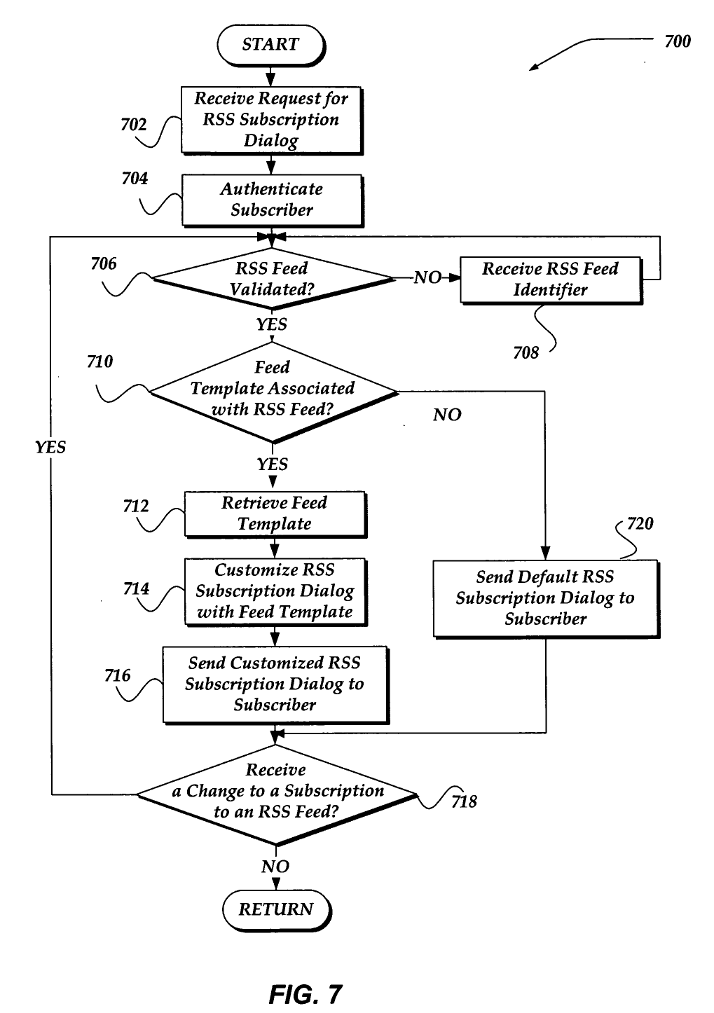

Subscription manager 237 is configured to provide a subscription dialog interface to another network device, such as client devices 130-132, to enable a user to manage a subscription to an RSS feed. Subscription manager 237 may receive from a template store, such as template store 136 of FIG. 1, or the like, a feed template. Subscription manager 237 may provide the feed template to customizer 238. Customizer 238 may then be configured to customize an RSS subscription dialog with the feed template and provide the customized RSS subscription dialog to subscription manager 237. In another embodiment, customizer 238 may receive the feed template from the template store, rather than receive it from subscription manager 237. In addition, in one embodiment, customizer 238 may also receive information from a subscriber profile store, such as subscriber store 110, and employ such information as part of customization of the RSS subscription dialog. Subscription manager 237 and customizer 238 may employ a process such as described below in conjunction with FIG. 7 to perform at least some of the above actions.

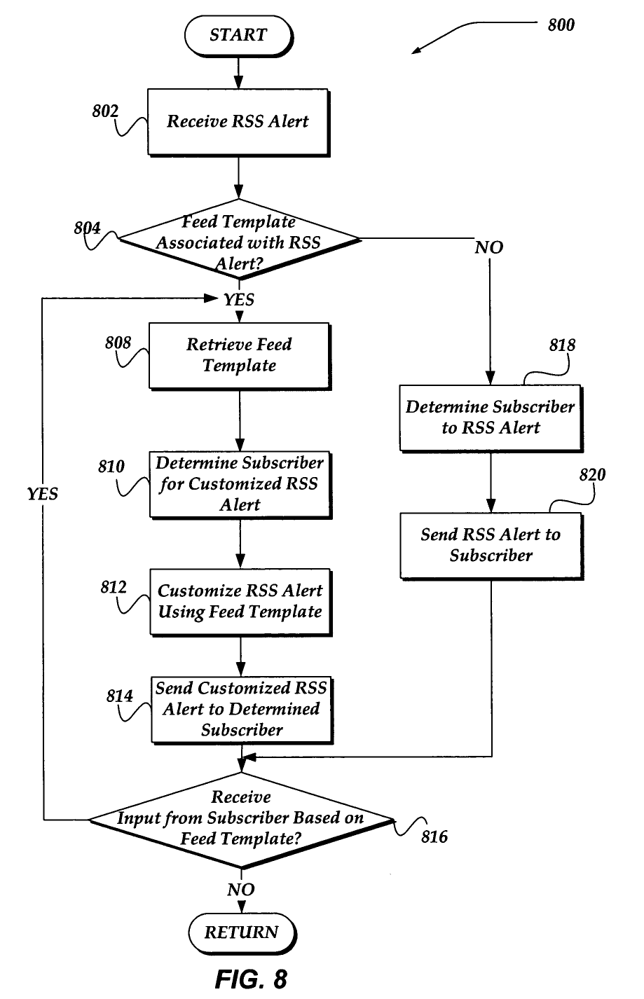

Delivery manager 236 is configured to provide delivery of an RSS alert and/or RSS feed content to a subscriber. Delivery manager 236 may provide such material to the subscriber using a variety of mechanisms, including, but not limited to, email, SMS, voice, IM, web browser, or the like. Delivery manager 236 may provide such information using a feed template. Delivery manager 236 may receive provide information to customizer 238 with which customizer 238 may employ to customize an RSS alert, content, or the like. In one embodiment customizer 238 may also receive information from the template store, and/or subscriber store, such as template store 136 and subscriber store 110 of FIG. 1, respectively. Customizer 238 may then employ a feed template and/or subscriber profile information to customize the RSS alert and/or content. Delivery manager 236 and customizer 238 may employ a process such as described below in conjunction with FIG. 8 to perform at least some of the above actions.

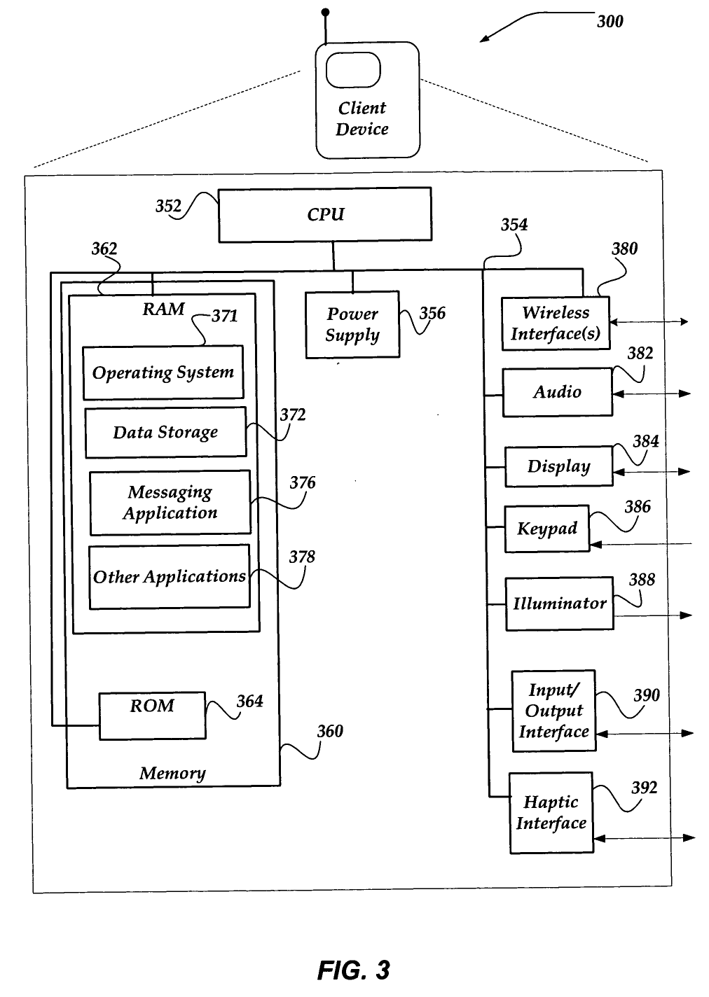

FIG. 3 shows one embodiment of a client device that may operate as a client device, such as client devices 130-132 of FIG. 1. In one embodiment, client device 300 is a mobile phone that is arranged to send and receive voice communications, text-based messages, multimedia data, and other data by way of one or more wireless communication interfaces. Generally, client device 300 may include any electronic device capable of such wireless communication, including, but not limited to, any personal electronic device. Client devices are typically capable of communication by connecting to one or more wireless networks, connecting to multiple nodes of a single wireless network, communicating over one or more channels to one or more networks, or otherwise engaging in one or more communication sessions. Such devices include mobile phones, cellular phones, smart phones, pagers, RF devices, IR devices, integrated devices combining one or more of the preceding devices, and the like. Client device 300 may also include other electronic devices such as personal digital assistants, handheld computers, personal computers, microprocessor-based or programmable consumer electronic devices, wearable computers, and the like.

Client device 300 may include many more components than those shown in FIG. 3, and need not include all of the components shown therein. However, the components shown are sufficient to disclose an illustrative embodiment for practicing the present invention. As shown in the figure, client device 300 includes CPU 352 in communication with memory 360 by way of bus 354.

Client device 300 also includes power supply 356, one or more wireless interfaces 380, audio interface 382, display 384, keypad 386, illuminator 388, input/output interface 390, and haptic interface 392. Power supply 356 provides power to client device 300. A rechargeable or non-rechargeable battery may be used to provide power. The power may also be provided by an external power source, such as an AC adapter or a powered docking cradle that supplements and/or recharges a battery.

Client device 300 may optionally communicate with a base station (not shown), or directly with another wireless mobile or non-mobile device. Input/output interface 390 includes circuitry for coupling client device 300 to one or more wireless networks, and is constructed for use with one or more communication protocols and technologies including, but not limited to, GSM, CDMA, TDMA, EDGE, UMTS, WCDMA, CDMA 2000, UDP, TCP/IP, SMS, GPRS, WAP, UWB, WiMax, IEEE 802.11x, and the like. Audio interface 382 is arranged to produce and receive audio signals, such as the sound of a human voice. For example, audio interface 382 may be coupled to a speaker and microphone (not shown) to enable telecommunication with others and/or to generate an audio acknowledgement for some action. Display 384 may be a liquid crystal display, gas plasma, light emitting diode, or any other type of display used with a client device or other wireless device. Display 384 may also include a touch sensitive screen arranged to receive input from an object such as a stylus or a human digit.

Keypad 386 may include any input device arranged to receive input from a user. For example, keypad 386 may include a push button numeric dial or an alphanumeric keyboard. Keypad 386 may also include command buttons that are associated with selecting and sending images. Illuminator 388 may provide a status indication and/or provide light. Illuminator 388 may remain active for specific periods of time or in response to events. For example, if illuminator 388 is active, it may backlight the buttons on keypad 386 and remain active while client device 300 is powered. Also, illuminator 388 may backlight these buttons in various patterns if particular actions are performed, such as dialing another client device. Illuminator 388 may also cause light sources positioned within a transparent or translucent case of client device 300 to illuminate in response to actions.

Client device 300 also includes input/output interface 390 for communicating with external devices. Input/output interface 390 may employ one or more appropriate communication technologies, such as USB, IR, Bluetooth, and the like. Haptic interface 392 is arranged to provide tactile feedback to a user of client device 300. For example, haptic interface 392 may be employed to vibrate client device 300 in a particular way when a user of another device, such as a mobile phone, is calling client device 300.

Memory 360 may include RAM 362, ROM 364, and other storage means. Memory 360 also provides data storage 372 and storage of programs, including, for example, operating system 371, messaging application 376, and other applications 378. Such programs may include processor-executable instructions which, when executed on client device 300, cause transmission, reception, and other processing of audio data, video data, text messaging data, web pages, WML pages, and the like, and enable wireless communication with another device.

Messaging application 376 is configured to receive RSS feeds, including an RSS alert, and/or RCS content. Messaging application 376 may receive the RSS feeds using any of a variety of messaging protocols, including, but not limited to HTML, XML, email, IM, or the like. In one embodiment, the messaging application may receive messages through a Multimedia Message Service (MMS), instant messaging, Short Message Service (SMS), internet relay chat (IRC), Mardam-Bey's IRC (mIRC), Jabber, and the like. Messaging application 376 may use a browser application to format and display RSS feeds. In one embodiment, the browser application is enabled to employ at least HTML, Dynamic HTML, HDML, WML, WMLScript, JavaScript, xHTML, CHTML, and the like. In another embodiment, the messaging application 376 may use a proprietary graphical user interface. In one embodiment, the messaging application is adapted to receiving at least one message and displaying the messages in real-time.

Messaging application 376 may further receive an RSS alert indicating that RSS content is available for access by client device 300. In one embodiment messaging application 376 may, in part, establish a network connection with a delivery server, such as RSS delivery server 124 of FIG. 1 to access the content and/or an RSS alert. In another embodiment, the messaging application requests RSS delivery server 124 for content that is available through a network connection, receives an alert indicating that the RCS content is available, or the RCS content itself, and displays the RSS alert and/or RCS content possibly in real-time by way of a browser application or a proprietary graphical user interface.

Messaging application 376, and/or another application, such as a client application within other applications 378 may be employed to enable a user of client device 300 to manage a subscription to an RSS feed. Thus, messaging application 376 may be configured to receive a menu, or other interface that allows the user to add, delete, search for, or modify an RSS feed. Moreover, messaging 376 may further be configured to receive and provide to a user, a feed template that the user may then view. Such feed templates may be integrated with a subscription dialog menu or other interface, and/or a delivery menu or other interface.

FIG. 4 shows one embodiment of an RSS feed subscription dialog customized with a feed template. Customized subscription dialog 400 of FIG. 4 may include more or less components than those shown. However, the components shown are sufficient to disclose an illustrative embodiment for practicing the present invention.

As shown, customized subscription dialog 400 includes menu interface 402, which in turn includes feed template 404. Feed template 404 may represent virtually any of a variety of RCS related information that may be arranged for display within menu interface 402. Such information may include, as described above, branding information, links, sponsorship information, information associated with related feeds, advertisements, or the like. Such information may also be configured to dynamically change based on a behavior of a user, a time of day, a product and/or service, or the like. Thus, feed template 404 may include static content, dynamic content, and/or interactive content.

FIG. 5 shows one embodiment of another customized subscription dialog useable during at least a portion of an RSS feed subscription action. As shown in the figure, customized subscription dialog 500 includes feed template 504 below menu interface 502. As shown in FIGS. 4-5, the feed templates (404 and 504) may be integrated with the menu interface at a variety of locations. Moreover, although not shown, a menu interface may include a plurality of feed templates, feed templates of various sizes, feed templates interspersed within a portion of the menu interface, above, and/or on a right side of the menu interface, or the like. Thus, customization of a subscription dialog is not restricted to the examples shown, and virtually any organization of the feed template with the menu interface may be employed, without departing from the scope or spirit of the invention. For example, as a user interacts with the menu interface, the layout and/or content of the feed template may change.

FIG. 6 shows one embodiment of an RSS alert customized with feed templates. As shown, RSS alert 600 shows RSS alert content 602, and feed templates 604-605. As shown, multiple feed templates may be used to customize an RSS alert, as well. Also, as described above with FIGS. 4-5, a feed template's size, location, and/or content, may vary. Moreover, although FIG. 6 illustrates use of a feed template with an RSS alert. The invention is not so constrained. For example, an RSS feed may also be customized with feed templates substantially similar to RSS alert 600.

Generalized Operation

The operation of certain aspects of the invention will now be described with respect to FIGS. 7-8. FIG. 7 illustrates a logical flow diagram generally showing one embodiment of a process for managing a customized RSS feed subscription. Process 700 of FIG. 7 may be employed by subscription server 106 of FIG. 1.

Process 700 begins, after a start block, at block 702 where a request is received for an RSS subscription dialog. The request may be-received by a user of a client device, such as client devices 130-131 of FIG. 1. The request may be to add a new RSS feed subscription, delete an existing RSS feed subscription, and/or modify an RSS feed subscription. Such modifications may include modifying how the user receives an RSS alert and/or content, how often the user receives the RSS alert, or the like.

Processing then flows to block 704 where the subscriber is authenticated. Authentication of the subscriber may be performed using a variety of mechanisms, including a username/password, digital certificate, or the like. Such authentication may, for example, be against a subscription data store managed, at least in part, by subscription server 106. In any event, if the subscriber is authenticated, processing proceeds to decision block 706. Although not shown, if the subscriber is not authenticated, processing may be terminated, the subscriber may be permitted to attempt another authentication, or the like.

At decision block 706 a determination is made whether the RSS feed requested by the subscriber at block 702 is valid. An RSS feed may not be valid for a variety of reasons, including, the RCS has terminated the feed, the RSS feed identifier provided by the subscriber is incorrectly entered, or the like. In any event, if the RSS feed requested by the subscriber is invalid, processing may flow to block 708, where the subscriber may be requested to re-enter the RSS feed identifier. Processing then loops back to decision block 706. Although not illustrated, process 700 may be configured to allow the subscriber to make a pre-determined number of attempts before exiting, may provide suggested RSS feed identifiers that are similar to the invalid RSS feed identifier provided by the subscriber, or the like.

In any event, if at decision block 706, it is determined that the RSS feed requested is valid, processing continues to decision block 710 to determine whether a feed template is associated with the requested RSS feed. If not, processing may proceed to block 720, where a default RSS subscription dialog is sent to the subscriber for use in managing the RSS feed subscription. Processing then flows to decision block 718.

If, at decision block 710, it is determined that a feed template is associated with the requested RSS feed, processing proceeds to block 712, where the feed template is retrieved. Process 700 continues to block 714 where the RSS subscription dialog is customized with the feed template. Such customized may also include modifying the RSS subscription dialog based on a client device's capability. For example, where the client's device is a mobile device, such as a cellular phone, the RSS subscription dialog may be customized for smaller screen size than say a desktop device's screen size, or the like. Thus, in one embodiment, where the feed template may include a logo, or other graphic, customization may modify the RSS subscription dialog to show a link, short text, or the like. The link may be employed to access the logo, graphic, or another display associated with the feed template. In any event, processing then proceeds to block 716, where the customized RSS subscription dialog is sent to the subscriber.

Processing next continues to decision block 718, where a determination is made whether a change to a subscription to an RSS feed is received. Such change may include an addition, a deletion, a modification, or the like. In any event, if no change is received, process 700 then returns to the calling process to perform other actions.

However, if a change is received, processing loops back to decision block 706. By looping back through the above, a different feed template may be retrieved at block 712, based at least in part on the received change to the subscription at decision block 718. Thus, as the subscriber interacts with the customized subscription dialog, the feed template may vary. For example, as the subscriber modifies a delivery mechanism, adds a new RSS feed, or performs another actions, the feed template being provided to the subscriber may vary so as to display a different advertisement, product, service, brand, co-brand, or the like.

FIG. 8 illustrates a logical flow diagram generally showing one embodiment of a process for managing a customized RSS alert to a subscriber. Process 800 of FIG. 8 may be implemented, for example, within RSS delivery server 124 of FIG. 1. Process 800 begins, after a start block, at block 802, when an RSS alert is received that is to be delivered to a subscriber. In one embodiment, the RSS alert may include content associated with the RSS alert. In one embodiment, the RSS alert is provided by a match server, such as match servers 122-123 of FIG. 1.

Processing flows next to block 804, where a determination is made whether a feed template is associated with the RSS alert. If a feed template is associated with the RSS alert, processing flows to block 808; otherwise, processing branches to block 818.

At block 808, the feed template is retrieved. In one embodiment, the feed template may be retrieved from a template store, such as template store 136 of FIG. 1. Processing continues next to block 810, where the subscriber is determined for which the RSS alert is to be provided. In one embodiment, a match server, such as match servers 122-123 of FIG. 1, may provide a list of one or more subscribers for the RSS alert. Moreover, a mechanism for delivery, such as email, SMS, IM, web, or the like, may be associated with each subscriber. Also, each subscriber may have associated with them, a client device, for which the RSS alert is to be sent.

Processing continues to block 812, where the RSS alert is customized using the feed template. In one embodiment, the RSS alert is customized further based on the client device, and/or mechanism for which the RSS alert is to be delivered to. For example, where the RSS alert is to be delivered over SMS, the customized RSS alert may include a link, text, or the like from the feed template, rather than a logo, or other graphic. Processing flows next to block 814, where the customized RSS alert may be sent to the determined subscriber(s).

Process 800 flows next to decision block 816, where a determination is made whether an input is received from the subscriber based, at least in part on information within the feed template. Such input may be to select information within the feed template or the like. In one embodiment, the selection may result in sending the subscriber to a network address based on the selected information. In another embodiment, however, the selection may result in providing a different feed template to the subscriber. Thus, in one embodiment, if no input is received then process 800 returns to a calling process to perform other actions. However, if input is received that may result in a different feed template being selected; processing loops back to block 808.

At block 818, the subscriber(s) to the alert are determined. Block 818 may be substantially similar to block 810 described above. Processing flows next to 820 where the RSS alert is provided to the subscriber(s). Processing then flows to decision block 816, described above.

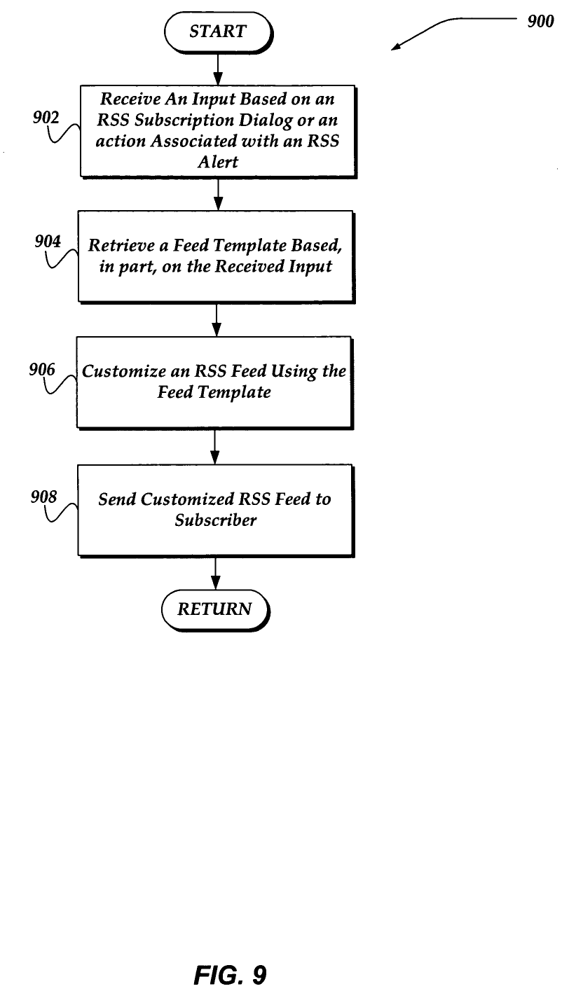

FIG. 9 illustrates a logical flow diagram generally showing one embodiment of a process for customizing an RSS feed based on an input from a subscription dialog or an RSS alert. Thus process 900 of FIG. 9 may be entered when an input is received from a subscription dialog based, in part, on a viewed feed template, or based on a customized RSS alert. Such input from a customized RSS alert may arise, for example, when a subscriber selects content within the feed template, or the like. In one embodiment, the input may also be received based on an action associated with an RSS feed. For example, the subscriber may select content within the feed template associated with the RSS feed.

Process 900 begins, after a start block, at block 902 when an input is received based on an RSS subscription dialog, or an action associated with an RSS alert. Processing then proceeds to block 904, where a feed template is retrieved, as described above, based, at least in part, on the received input. The input may also be received based on an action associated with an RSS feed.

Processing continues to block 906, where the feed template is employed to customize an RSS feed. As described above, the feed template may include various content, including a brand, advertisement, or the like, that may be inserted or otherwise integrated with the RSS feed content. Processing then flows to block 908, where the customized RSS feed is sent to at least one subscriber. In one embodiment, use of the feed template results in receiving of revenue.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A system for managing RSS content over a network, comprising:
an RSS feed template component that is configured to store RSS feed templates;
a subscription component that is in communication with the RSS feed template and is operative to perform actions, comprising:
providing an RSS subscription interface;
receiving an input based, in part, on the RSS subscription interface; and
an RSS delivery component that is in communication with the RSS feed template and subscription component and is operative to perform actions, comprising:
employing an RSS feed template to customize content of an RSS feed based on the input received by the subscription component; and
sending the customized RSS feed to a client device.

2. The system of claim 1, wherein the RSS feed template further comprises at least one of a brand, an advertisement, a graphic, or a link.

3. The system of claim 1, wherein the RSS feed template is obtained from least one of an RSS content source provider, an RSS subscription service provider, or a third party.

4. The system of claim 1, the actions of the RSS delivery component further comprising:
receiving revenue based on the customization of the RSS feed.

5. The system of claim 1, wherein the RSS subscription interface is further customized using another RSS feed template.

6. A method of managing RSS content over a network, comprising:
employing a first RSS feed template to customize an RSS subscription interface;
receiving an input based, in part, on the first RSS feed template;
employing a second RSS feed template to customize content of an RSS feed based on the input; and
sending the customized RSS feed to a client device.

7. The method of claim 6, wherein at least one RSS feed template is provided by at least one of an RSS content source provider, an RSS subscription service provider, or a third party.

8. The method of claim 6, further comprising
receiving revenue based on at least one RSS feed template.

9. The method of claim 6, further comprising:
employing a third RSS feed template to customize an RSS alert;
sending the customized RSS alert to a client device;
receiving another input based in part on the customized RSS alert; and
customizing another RSS feed using a fourth RSS feed template based, in part, on the other input.

10. The method of claim 6, wherein at least one of the RSS feed or the RSS subscription interface is further customized based on a characteristic of the client device.

11. The method of claim 6, wherein a modulated data signal is configured to include program instructions for performing the method of claim 6.

12. A server that is configured to manage RSS content over a network, comprising:
a transceiver for receiving and for sending information over the network; and
program code that is operative to perform actions comprising:
employing an RSS feed template to customize an RSS subscription interface;
receiving an input based, in part, on the RSS feed template;
employing another RSS feed template to customize content of an RSS feed based on the input; and
sending the customized RSS feed to a client device.

13. The server of claim 12, wherein the RSS feed is associated with at least one of a blog, news source, educational institution, legal institution, a business, financial institution, or a sport.

14. The server of claim 12, wherein at least one billing account is charged based on usage of at least one RSS feed template.

15. The server of claim 12, wherein at least one RSS feed template further comprises at least one of a brand, an advertisement, a graphic, picture, movie, or a link.

16. The server of claim 12, wherein at least one RSS feed template is provided by at least one of an RSS content source provider, an RSS subscription service provider, or a third party.

17. A client that is operative for managing an RSS message over a network, comprising:
providing an input based, in part, on an RSS subscription interface; and
receiving a customized RSS feed, wherein the content of the RSS feed is customized using an RSS feed template and is further based, in part, on the provided input.

18. The client of claim 17, wherein providing the input results in revenue from at least one account associated with a source of the RSS feed template.

19. The client of claim 17, wherein receiving the customized RSS feed further comprises the RSS feed template being located within the RSS feed on at least one of a side bar, a top bar, or a bottom bar location.

20. The client of claim 17, wherein at least a portion of the RSS feed template includes dynamic content.

21. The client of claim 17, wherein the RSS feed template comprises at least one of a brand, an advertisement, a graphic, picture, movie, or a link.

22. The client of claim 17, wherein the RSS feed template is provided by at least one of an RSS content source provider, an RSS subscription service provider, or a third party.

23. A processor readable medium that includes data, wherein the execution of the data provides for the management of RSS content over a network by enabling actions, comprising:
receiving an input based, in part, on an RSS subscription interface;
employing an RSS message template to customize content of an RSS feed based on the input; and
sending the customized RSS message to a client device.

24. The processor readable medium of claim 23, wherein the RSS message further comprises at least one of an RSS feed, or an RSS alert.

25. The processor readable medium of claim 23, wherein at least one billing account is charged based, in part, on at least one RSS feed template.
